(19) United States
(12) Patent Application Publication
(10) Pub. No.: US 2018/0199560 A1
(43) Pub. Date: Jul. 19, 2018

(54) HOOKED ON BOTTOM BOUNCER DEVICE

(71) Applicant: Michelle Treiber, Curtis, MI (US)

(72) Inventor: Michelle Treiber, Curtis, MI (US)

(21) Appl. No.: 15/924,257

(22) Filed: Mar. 18, 2018

(51) Int. Cl. A01K 95/00; A01K 85/10

(52) U.S. Cl. CPC A01K 95/00; A01K 85/10

(57) ABSTRACT

A bottom bouncer used in combination with a fishing lure is disclosed. The bottom bouncer facilitates the positioning and movement of fishing lure under water. The bottom bouncer comprises a first central axis, a second central axis, a plurality of components and a weighted body. The first central axis connects the bottom bouncer to a fishing line and the fishing lure. The plurality of components includes beads, wedding band beads, floats, and propeller, capable of flashing, spinning and floating when drifted underwater for attracting the predatory fishes. The bottom bouncer further comprises a second central axis with the weighted body capable of positioning the fishing lure at a particular height from the bottom surface of the water.

### BACKGROUND

### Technical Field

The embodiments herein are generally related to a fishing equipment. The embodiments herein are particularly related to a bottom bouncer for fishing lures. The embodiments herein are more particularly related to a bottom bouncer used in a complimentary manner with fishing lures to facilitate proper placement and movement of the fishing lure.

### Description of the Related Art

Bottom bouncers are used as a fishing aid since long years. Typically, bottom bouncers are weights/heavy body or sinkers used for carrying a fishing line to the bottom surface of the water. The weight/heavy body comprises an upper shaft and a lower shaft attached on two sides. The upper shaft is secured to the fishing line and the lower shaft is engaged with the bottom surface of the water, thereby holding the fishing line at a particular height above the bottom surface of the water.

However, the conventional bottom bouncers are not capable of holding a fishing lure attached to the fishing line in a steady position when trolled or drifted over the bottom surface of the water. When the fishing lure is not held in a proper position, debris such as weeds become hooked on the fishing lure and fishing line. Further, the attachment of the upper shaft to a fishing line and a fishing lure becomes difficult.

Hence, there is a need for a bottom bouncer for facilitating a positioning and movement of a fishing lure. There is also a need for a bottom bouncer for positioning fishing lure along a weed-line. Further, there is a need for a bottom bouncer that flashes, spins and floats to attract predatory fishes to fishing line. Furthermore, there is a need for a bottom bouncer that is easily attached to a fishing line and a fishing lure.

The above-mentioned shortcomings, disadvantages, and problems are addressed herein and which will be understood by reading and studying the following specification.

### OBJECTIVES OF THE EMBODIMENTS HEREIN

The primary object of the embodiments herein is to provide a bottom bouncer used in a complimentary manner with fishing lures.

Another object of the embodiments herein is to provide a bottom bouncer designed with elements that are formed complimentary to the elements of a fishing lure for enabling an efficient trolling process.

Yet another object of the embodiments herein is to provide a bottom bouncer capable of attracting predatory fishes to a fishing line.

Yet another object of the embodiments herein is to develop a bottom bouncer loaded with floats, beads, wedding band beads, propellers and blades.

Yet another object of the embodiments herein is to provide a bottom bouncer used in conjunction with a fishing lure to facilitate a correct placement and a steady movement of a fishing lure underwater while trolling.

Yet another object of the embodiments herein is to develop a bottom bouncer provided with spinning and floating elements to create waves movement in water for attracting predatory fishes.

Yet another object of the embodiments herein is to provide a bottom bouncer capable of holding the fishing lure along a weed-line rather than on weeds.

Yet another object of the embodiments herein is to provide a bottom bouncer loaded with a safety snap and a slot to enable attachment to a fishing lure and a fishing line respectively.

These and other objects and advantages of the embodiments herein will become readily apparent from the following detailed description taken in conjunction with the accompanying drawings.

### SUMMARY OF THE EMBODIMENTS HEREIN

The embodiments herein provide a bottom bouncer used in conjunction with a fishing lure to facilitate a placement and movement of the fishing lure underwater. The bottom bouncer comprises a weight/heavy body configured to place/position a fishing lure at the bottom surface of the water. Further, the fishing lure is drifted and trolled underwater in a steady position using the bottom bouncer. The bottom bouncer floats and spins in two directions thereby attracting predatory fishes to the fishing line.

According to an embodiment herein, a bottom bouncer for facilitating positioning and movement of a fishing lure is disclosed. The bottom bouncer comprises a first central axis, a plurality of components and a second central axis. The first central axis is configured to connect the bottom bouncer to a fishing line and the fishing lure. The first central axis comprises a safety snap at one end for connecting the bottom bouncer to the fishing lure and a slot at another end for connecting the bottom bouncer to the fishing line. The plurality of components is configured for attracting the predatory fishes to the fishing lure. The plurality of components are assembled on the first central axis. The plurality of components comprises beads, wedding band beads, floats, propeller and blades that are configured to float and spin to attract the predatory fishes. The second central axis comprises a weight/heavy body configured for positioning the fishing lure underwater. The weight/heavy body pulls the fishing line and the fishing lure to the bottom surface of the water. Further, the weight/heavy body is designed/configures to keep the fishing lure in a steady position when the fishing line is drifted and trolled underwater.

According to an embodiment herein, each component among the plurality of components comprises an orifice for receiving the central axis.

According to an embodiment herein, the plurality of components is assembled on the central axis in the order of a first bead, a second bead, a wedding band bead, a third bead, a fourth bead, a float, a fifth bead, a propeller and a sixth bead from one end of the first central axis connected to the fishing lure.

According to an embodiment herein, the bottom bouncer is configured to float and spin both in a clockwise direction and in a counter-clockwise direction.

According to an embodiment herein, the first central axis and the second central axis are made of material selected from a group consisting of a metal wire, thread, and plastic wire.

According to an embodiment herein, the plurality of components is designed in a color selected from a group consisting of red, blue, green, and a color formed by a combination of a red, green or blue.

According to an embodiment herein, the first bead, the fourth bead, the fifth bead and the sixth bead are designed to have a first preset size, and wherein the first preset size is four millimeter in diameter.

According to an embodiment herein, the second bead and the third bead are designed to have a second preset size, and wherein the second preset size is six millimeter in diameter.

According to an embodiment herein, the first bead, the second bead, the third bead, the fourth bead, the fifth bead and the sixth bead are configured to act as a flash.

According to an embodiment herein, the propeller is configured to spin in both clockwise and counter-clockwise direction.

According to an embodiment herein, the float is configured to float and spin in both clockwise direction and counter-clockwise direction.

According to an embodiment herein, the wedding band beads are configured to act as a flash and spin in both in a clockwise direction and in a counter-clockwise directions.

According to an embodiment herein, the weight/heavy body is made of lead.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment and the accompanying drawings in which:

FIG. 1 illustrates a plan view of a bottom bouncer, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a bottom bouncer used in conjunction with a fishing lure to facilitate a placement and movement of the fishing lure underwater. The bottom bouncer comprises a weight/heavy body configured to place/position a fishing lure at the bottom surface of the water. Further, the fishing lure is drifted and trolled underwater in a steady position using the bottom bouncer. The bottom bouncer floats and spins in two directions thereby attracting predatory fishes to the fishing line.

According to an embodiment herein, a bottom bouncer for facilitating positioning and movement of a fishing lure is disclosed. The bottom bouncer comprises a first central axis, a plurality of components and a second central axis. The first central axis is configured to connect the bottom bouncer to a fishing line and the fishing lure. The first central axis comprises a safety snap at one end for connecting the bottom bouncer to the fishing lure and a slot at another end for connecting the bottom bouncer to the fishing line. The plurality of components is configured for attracting the predatory fishes to the fishing lure. The plurality of components are assembled on the first central axis. The plurality of components comprises beads, wedding band beads, floats, propeller and blades that are configured to float and spin to attract the predatory fishes. The second central axis comprises a weight/heavy body configured for positioning the fishing lure underwater. The weight/heavy body pulls the fishing line and the fishing lure to the bottom surface of the water. Further, the weight/heavy body is designed/configures to keep the fishing lure in a steady position when the fishing line is drifted and trolled underwater.

According to an embodiment herein, each component among the plurality of components comprises an orifice for receiving the central axis.

According to an embodiment herein, the plurality of components is assembled on the central axis in the order of a first bead, a second bead, a wedding band bead, a third bead, a fourth bead, a float, a fifth bead, a propeller and a sixth bead from one end of the first central axis connected to the fishing lure.

According to an embodiment herein, the bottom bouncer is configured to float and spin both in a clockwise direction and in a counter-clockwise direction.

According to an embodiment herein, the first central axis and the second central axis are made of material selected from a group consisting of a metal wire, thread, and plastic wire.

According to an embodiment herein, the plurality of components is designed in a color selected from a group consisting of red, blue, green, and a color formed by a combination of a red, green or blue.

According to an embodiment herein, the first bead, the fourth bead, the fifth bead and the sixth bead are designed to have a first preset size, and wherein the first preset size is four millimeter in diameter.

According to an embodiment herein, the second bead and the third bead are designed to have a second preset size, and wherein the second preset size is six millimeter in diameter.

According to an embodiment herein, the first bead, the second bead, the third bead, the fourth bead, the fifth bead and the sixth bead are configured to act as a flash.

According to an embodiment herein, the propeller is configured to spin in both clockwise and counter-clockwise direction.

According to an embodiment herein, the float is configured to float and spin in both clockwise direction and counter-clockwise direction.

According to an embodiment herein, the wedding band beads are configured to act as a flash and spin in both in a clockwise direction and in a counter-clockwise directions.

According to an embodiment herein, the weight/heavy body is made of lead.

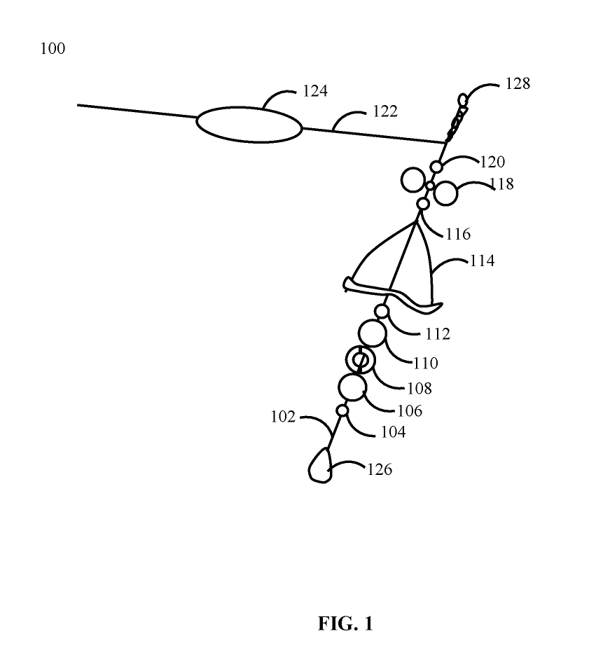

FIG. 1 illustrates a bottom bouncer, according to one embodiment herein. The bottom bouncer 100 is used in conjunction with a fishing lure. The bottom bouncer 100 facilitates proper placement and movement of the fishing lure underwater. The bottom bouncer 100 flashes, floats and spins underwater to attract predatory fishes to the fishing lure. The examples of predatory fishes include but are not limited to walleye, perch, pike and bass. The bottom bouncer 100 is designed to mimic physical characteristics of a live bait/prey including colors and movements. The bottom bouncer 100 comprises a first central axis 102, a second central axis 122, a plurality of components 104, 106 . . . 120 and a weighted body 124.

The first central axis 102 is configured to connect one end of the bottom bouncer 100 to a fishing line and the other end to the fishing lure. The first central axis 102 comprises a safety snap 126 for connecting the bottom bouncer 100 to the fishing lure. The fishing lure is easily attached to the safety snap 126. The fishing lure is attached to the first central axis such that the fishing lure and the first central axis 102 of the bottom bouncer 100 appear or are aligned to be in one line when trolled or drifted underwater.

According to one embodiment herein, the plurality of components 104, 106 . . . 120 on the bottom bouncer are designed to be complimentary elements to the elements on the fishing lure, thereby providing an even/uniform presentation of fishing lure and bottom bouncer underwater while trolling. Further, the first central axis 102 comprises a slot 128 for connecting the bottom bouncer 100 to the fishing line. The first central axis 102 is made of material selected from a group consisting of a metal wire, thread, and plastic wire.

The bottom bouncer 100 comprises the plurality of components 104, 106 . . . 120 assembled on the first central axis 102. Each component among the plurality of components 104, 106 . . . 120 comprises an orifice for accommodating/receiving the first central axis 102. The plurality of components 104, 106 . . . 120 is configured to flash and spin on the first central axis 102 for attracting the predatory fishes to the fishing lure. The plurality of components 104, 106 . . . 120 comprises beads, wedding band beads, floats, propeller and blades, that floats and spins to attract the predatory fishes. The plurality of components 104, 106 . . . 120 are designed to float and spin in either directions, thereby creating movements in the water to summon predatory fishes.

The pluralities of components 104, 106. . . . 120 are assembled in the order of a first bead 104, a second bead 106, a wedding band bead 108, a third bead 110, a fourth bead 112, a float 114, a fifth bead 116, a propeller 118 and a sixth bead 120 from one end of the first central axis 102 connected to the fishing lure. The plurality of components 104, 106 . . . 120 is designed to have a color selected from a group consisting of red, blue, green, and a color formed by a combination of a red, green or blue. Among the plurality of components 104, 106 . . . 120, the first bead 104, the fourth bead 112, the fifth bead 116 and the sixth bead 120 are designed to have diameter in a first preset size. According to one embodiment herein, the first preset size is four millimeter. Further, the second bead 106 and the third bead 110 are designed to have diameter in a second preset size. According to one embodiment herein, the second preset size is six millimeter. The size of the beads are designed such that the beads spin freely in either directions. The first bead 104, the second bead 106, the third bead 110, the fourth bead 112, the fifth bead 116 and the sixth bead 120 are provided with fluorescent bright colors to act as flash underwater.

The wedding band bead 108 is configured to act as a flash and spin in both clockwise and anti-clockwise directions. The wedding band bead 108 is configured to keep the fishing lure in steady position. The wedding band bead 108 is a light weight body. The bottom bouncer 100 when connected to a fishing lure has a wedding bead band. The wedding bead band 108 enables to balance the weight of the fishing lure and holds the fishing lure in steady position. The bottom bouncer 100 further comprises the propeller 118 which is configured to spin in both clockwise and counter-clockwise directions. The propeller 118 spins and flashes to create movement waves in water to summon predatory fishes underwater. The bottom bouncer 100 includes the float 114 that spins in both clockwise and counter-clockwise directions. The float 114 act as a flash to attract predatory fishes.

The bottom bouncer 100 further comprises the second central axis 122 with a weight body 124. The second central axis 122 is made of materials selected from a group consisting of a metal wire, thread, and plastic wire. A first end of the second central axis 122 is attached to the first central axis 102. The weight body 124 pulls the fishing line to the bottom of the water with a second end of the second central axis 122 engaging with the bottom surface of the water. The second central axis 122 is configured to stand vertically underwater with the first end positioned on the upper side and the second end engaging with the bottom surface of the water. The first central axis 102 attached to the second central axis 122 is thus held in a steady position at a particular height from the bottom surface of the water. Therefore, the fishing lure connected to the first central axis is held in steady position.

Further, the weight/heavy body 124 is configured to help the fishing lure 100 to overcome strong water currents. Further, any number of additional weights/heavy bodies is added when the water currents are prevalent. Thus the bottom bouncer 100 is used in conjunction with the fishing lure to catch fishes underwater. When the fishing line is lowered and drifted or trolled by a fishing person, the bottom bouncer 100 is pulled along with the fishing line with the second central axis 122 hitting the bottom surface of the water. Therefore, the fishing lure is held in steady position when trolled underwater. The bottom bouncer 100 along with the fishing lure is configured to attract more predatory fishes. The bottom bouncer 100 is designed to keep the fishing lure along the weed-line with more even presentation without getting hooked on the weeds.

Therefore, the bottom bouncer 100 along with the fishing lure is capable of flashing, spinning and floating in water, thereby appearing as a natural prey to the predatory fishes. The bottom bouncer 100 and the fishing lure flashes to draw the attention of the predatory fishes far away from the fishing line. The bottom bouncer 100 and the fishing lure further floats and spins slowly by consistently attracting the predatory fishes to the fishing line until they are trapped. The bottom bouncer 100 is used in combination with any types of fishing lures or crawler harness to facilitate their placement and movement underwater while trolling.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A bottom bouncer device for facilitating a positioning and a movement of a fishing lure, the bottom bouncer comprising:
a first central axis configured to connect the bottom bouncer to a fishing line and the fishing lure, wherein the first central axis comprises a safety snap at one end for connecting the bottom bouncer to the fishing lure and a slot at another end for connecting the bottom bouncer to the fishing line;
a plurality of components configured for attracting predatory fishes to the fishing lure, wherein the plurality of components is assembled on the first central axis, wherein the plurality of components comprises beads, wedding band beads, floats, and propeller, that floats and spins to attract the predatory fishes; and
a second central axis with a weight/heavy body configured for positioning the fishing lure underwater, wherein the weight body is designed/configured to pull the fishing line and the fishing lure to the bottom surface of the water and wherein the weight/heavy body is designed to keep the fishing lure in a steady position when the fishing line is drifted and trolled underwater.

2. The bottom bouncer as claimed in claim 1, wherein each component among the plurality of components comprises an orifice for accommodating/receiving the first central axis and the second central axis.

3. The bottom bouncer as claimed in claim 1, wherein the plurality of components is assembled on the central axis in the order of a first bead, a second bead, a wedding band bead, a third bead, a fourth bead, a float, a fifth bead, a propeller and a sixth bead from one end of the first central axis connected to the fishing lure.

4. The bottom bouncer as claimed in claim 1, wherein the bottom bouncer is configured to float and spin both in clockwise and counter-clockwise directions.

5. The bottom bouncer as claimed in claim 1, wherein the first central axis and the second central axis are made of material selected from a group consisting of a metal wire, thread, and plastic wire.

6. The bottom bouncer as claimed in claim 1, wherein the plurality of components is designed in a color selected from a group consisting of red, blue, green, and a color formed by a combination of a red, green or blue.

7. The bottom bouncer as claimed in claim 1, wherein the first bead, the fourth bead, the fifth bead and the sixth bead are designed to have a first preset size, and wherein the first preset size is four millimeter in diameter.

8. The bottom bouncer as claimed in claim 1, wherein the second bead and the third bead designed to have a second preset size, and wherein the second preset size is six millimeter in diameter.

9. The bottom bouncer as claimed in claim 1, wherein the first bead, the second bead, the third bead, the fourth bead, the fifth bead and the sixth bead are configured to act as a flash.

10. The bottom bouncer as claimed in claim 1, wherein the propeller is configured to spin in both clockwise and counter-clockwise directions.

11. The bottom bouncer as claimed in claim 1, wherein the float is configured to float spin in both clockwise and counter-clockwise directions.

12. The bottom bouncer as claimed in claim 1, wherein the wedding band beads are configured to act as a flash and spin in both clockwise and counter-clockwise directions.

13. The bottom bouncer as claimed in claim 1, wherein the weight/heavy body is made of lead.
